(19) United States
(12) Patent Application Publication
(10) Pub. No.: US 2006/0176152 A1
(43) Pub. Date: Aug. 10, 2006

(54) RFID power ramping for tag singulation

(75) Inventors: James Daniel Wagner, Tangent, OR (US); Kurt Ellis Steinke, Springfield, OR (US); Alan Christopher Bradley, Eugene, OR (US); Patrick Scott Watkins, Eugene, OR (US)

Correspondence Address: PSC SCANNING, INC. - STOEL RIVES LLP;C/O STOEL RIVES LLP, 900 SW 5TH AVENUE, SUITE 2600, PORTLAND, OR, 97204, US

(73) Assignee: PSC Scanning, Inc., Eugene, OR (US)

(21) Appl. No.: 11/055,960

(22) Filed: Feb. 10, 2005

(51) Int. Cl. H04Q 5/22

(52) U.S. Cl. 340/10.2; 340/10.3; 340/572.1

(57) ABSTRACT

A preferred embodiment is directed to a method of RFID power ramping for tag singulation that includes activating the trigger control of an RFID reader for engaging power to begin reading RFID tags. A user may take a first reading at a low power level of a volume around the RFID reader establishing a first read volume. If the user does not detect a particular RFID tag, the user may then increase the transmitting power from the RFID reader to a second higher power level obtaining a second reading of RFID tags in a second read volume. The user may once again increase the transmitting power from the RFID reader to a third higher power level obtaining a third reading of RFID tags in a third reading volume. Increasing the RFID transmitting power is repeated until there is a final read volume where the operator reads and recognizes the detected RFID tag. The final step includes deactivating the trigger control of the RFID reader after reading the desired RFID tag.

### TECHNICAL FIELD

The field of the disclosure relates to RFID readers and, more particularly, to a method of selecting a single RFID tag from a group of RFID tags.

### BACKGROUND

The use of Radio Frequency Identification (RFID) transponders or tags to identify an object or objects is well known in the art of RFID systems. Typically, when these tags are excited they produce or reflect a magnetic or electric field at some frequency, which is modulated with an identifying code or other useful information. The tag may either be active or passive. Active tags have a self-contained power supply. Passive tags require external excitation when they are to be read within the detection volume of a reader. In passive tag systems, the interrogator or reader contains a transmitting antenna for sending an exciting frequency signal to the passive tag. The transmitting antenna is positioned at the portal end and adjacent to an antenna for receiving a modulated signal (magnetic or electromagnetic) produced by the excited tag. This modulated signal identifies the tag and consequently, the object attached thereto.

There are problems in the detection of multiple RFID tags. The horizontal and vertical dimensions of the detection volume in which the RFID tags are to be read may contain a large number of tags. Reading RFID tags within the entire read volume can lead to a large number of response collisions (interference) when many tags are present. With a large number of collisions the interference between RFID tags reduces the accuracy of reading each individual tag and successive tags. In addition, because there is a large volume of space to read many tags it is difficult for a user of a RFID reader to physically locate a specific RFID tag.

Attempts have been made to improve the users' ability to physically locate a specific RFID tag. U.S. Pat. No. 6,377,203, issued to Doany, entitled “Collision Arbitration Method And Apparatus For Reading Multiple Radio Frequency Identification Tags,” identifies a method to read a specific tag using multiple colliding RF signals from different RFID tags. The technique uses a primary and multiple secondary communication channels. The secondary channels are assigned using a portion of the serial identification numbers for the tags, wherein the reader detects and commands a specific tag to the primary channel. Further RF signal collisions are possible and the collided tags are returned to the secondary channel and sorted again using another portion of the tags serial identification number. However, the process can provide a similar RF signal having similar modulation and data rates that creates coherent noise, wherein it is difficult to receive another signal.

U.S. Pat. No. 6,354,493, issued to Mon, entitled “System And Method For Finding A Specific RFID Tagged Article Located In A Plurality Of RFID Tagged Articles,” discloses a method to singulate RFID tags through the use of search criteria loaded into a processor. The processor compares the number of RFID tags matching the search criteria to the total RFID tag data received. This system is limited to identifying tags to within the search criteria. If a user wants to identify other RFID tags, new or additional search criteria must be loaded into the processor.

U.S. Pat. No. 6,265,962, issued to Black et al., entitled “Method For Resolving Signal Collisions Between Multiple RFID Transponders In A Field,” depicts a method to resolve the collisions among RF signals. The method comprises a transponder or tag receiving a carrier signal. The tag determines that it is time to transmit the data by verifying that it is in the transmit-armed state and that the carrier signal has been modified in a predetermined manner. The tag then determines how complete the data transmission was and if there were interfering signals. However, this process is time consuming as it is repeated until the tag determines that the complete data from the specific carrier signal has been read.

In U.S. Pat. No. 5,995,019, issued to Chieu et al., entitled “Method For Communicating With RF Transponders,” shows a method to select RF tags. A communication protocol selects groups of tags according to a specific signal attribute, for example, signal strength or phase polarization and then turns off tags or sets of tags. However, this method increases the complexity of an interrogator while being only partially effective in singulation. A set of tags or a tag has to be shut off in order to eliminate the signal collisions from those tags before a tag may be selected. The increasing of the RF transmitting power level, by itself, does not provide for singulation of a particular tag.

In another method of singulation, the interrogator in the RFID tag can send signals to allow tags to respond with a random number that is manipulated by the interrogator and transmitted to all tags in the field. Only the tag that matches the computed number generated by the interrogator will transmit its data. This process continues until all tags have transmitted their data. There are significant increases in complexity of the system because of computational requirements.

Yet another method of collision resolution is to cause tags to transmit at different frequencies, thereby avoiding a collision of signals. However, this method increases the complexity of an interrogator while being just partially effective in collision regulation.

Another method of singulation uses part of an identification code of the transponder to provide a specific time when data is transmitted. This method is limited by the number of transmission slots available and the time required reading all possible tags in the field. Moreover, a transponder could take an inordinate amount of time to be read.

Each of these existing systems to resolve RF signal collisions or improve singulation in RFID tags limitations or disadvantages. What is needed is a simple method of singulation that effectively detects an RFID tag or a group of RFID tags from a population or volume of RFID tags.

### SUMMARY

It is an aspect of the preferred embodiment to provide a method of RF signal collision reduction by a modulation scheme consisting of a sequence of increasing power levels.

It is another aspect of the preferred embodiment to provide at each successive reading, queries in a relatively small region (volume) reducing RF signal collision.

It is yet another aspect of the preferred embodiment to provide convenience relative to physically isolating each tag to be singulated and convenience relative to operating mode software menu selection.

It is still another aspect of the preferred embodiment to reduce antenna size and cost relative to narrow beam antennas.

It is yet still another aspect of the preferred embodiment to provide a simple method of singulation to select an RFID tag or tags from a population of RFID tags.

It is still yet another aspect of the preferred embodiment to reduce RF power output, reducing overall power consumption of hand-held RFID readers.

A preferred embodiment is directed to a method of RFID power ramping for tag singulation that includes activating the trigger control of an RFID reader for engaging power to begin reading RFID tags. A user may take a first reading at a low power level of a volume around the RFID reader establishing a first read volume.

If the user does not detect a particular RFID tag, the user may then increase the transmitting power from the RFID reader to a second higher power level obtaining a second reading of RFID tags in a second read volume. The user may once again increase the transmitting power from the RFID reader to a third higher power level obtaining a third reading of RFID tags in a third reading volume. Increasing the RFID transmitting power is repeated until there is a final read volume where the operator reads and recognizes the detected RFID tag. The final step includes deactivating the trigger control of the RFID reader after reading the desired RFID tag.

These and other aspects of the disclosure will become apparent from the following description, the description being used to illustrate the preferred embodiments when read in conjunction with the accompanying drawings.

### BRIEF DESCRIPTION of the DRAWINGS

FIG. 1 illustrates a block diagram of one embodiment.

FIG. 2 is a singulation scheme flowchart of one embodiment.

FIG. 3 illustrates a block diagram of one embodiment.

FIG. 4A illustrates how a read volume is processed for tag singulation in one embodiment.

FIG. 4B illustrates power modulation using tag singulation in one embodiment.

### DETAILED DESCRIPTION OF THE PREFERRED EMBODIMENTS

While the preferred embodiments are described below with reference to a RFID tag, a practitioner in the art will recognize the principals described herein are viable to other applications.

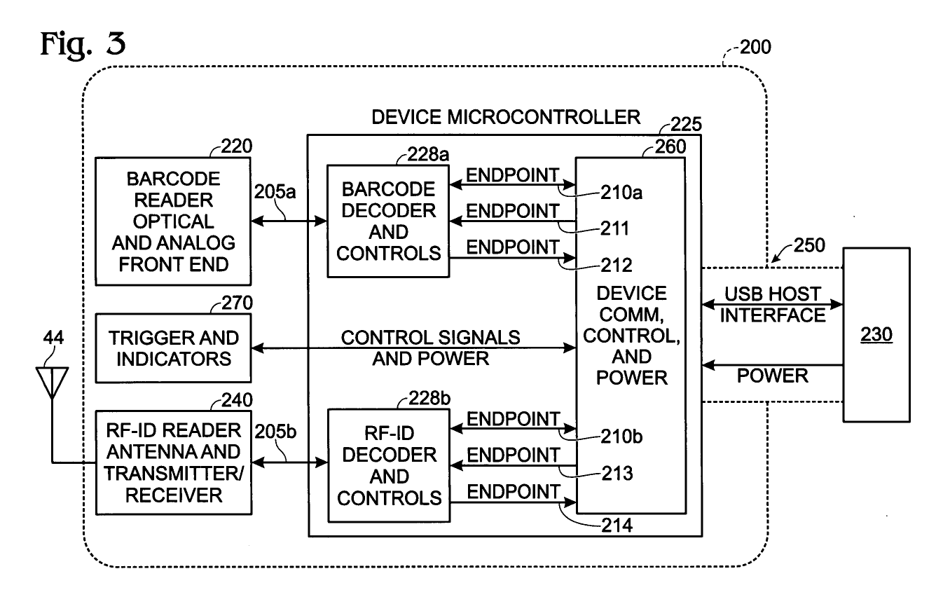

In a preferred embodiment as shown in FIG. 3, the multiple-technology data reader 200 includes the optical and analog front end components of a bar code reader 220. This reader 200 further includes an antenna 44 and transmitter/receiver components of an RFID interrogator 240, which are connected to a device microcontroller 225. The microcontroller 225 includes a decoder and control interface 228a for the bar code reader and another control interface 228b for the RFID reader. The decoder and control interfaces 228a and 228b are connected to a device communications control and power unit 260. The multiple technology data reader 200 also includes a trigger unit 270, which sends and receives control signals and power, both to and from the device communications control and power unit 260 on the microcontroller 225. The microcontroller 225 is connected to a host computer 230 via USB link 250, or other interfaces as is known to the practitioner of the art. The multiple-technology reader as described in U.S. Pat. No. 6,415,978, issued to McAllister, entitled “Multiple Technology Data Reader For Bar Code Labels And RFID Tags,” the entire contents of said patent are incorporated herein by reference and made part of this disclosure. This reader may use the principles of the preferred embodiment.

The reader device interfaces 228a has an input/output endpoint 210a, which enables the host computer 230 to use a default control method to initialize and configure the reader device interface 228a. Furthermore, the reader device interface 228a has an endpoint 211, which allows the host computer 230 to send data to the reader interface 228a, and an endpoint 212, which allows the reader device interface 228a to send data to the host computer 230. Data can be sent in either direction between the reader device interface 228a and the barcode reader subsystem 220 via a serial communications line 205a.

Likewise, reader device interface 228b has an input/output endpoint 210b, which enables the host computer 230 to use a default control method to initialize and configure the reader device interface 228b. In addition, endpoint 213 and endpoint 214, respectively, allow the host computer 230 to send data to the reader device interface 228b. Vice-versa, the reader device interface 228b can send data to the host computer 230. Data can be sent in either direction between the reader device interface 228b and the barcode reader subsystem 240 via a serial communications line 205b.

The trigger 270 may be used to adjust the RF power transmitted by the RFID reader relative to a single RFID tag of interest. That tag may be singulated with its individual identity read, even though more tags may be present within the normal read volume of the RFID reader and its antenna 44. In other words, other nearby tags are excluded through singulation. For example, if an initial trigger 270 pull results in transmission 6-10 db below the maximum allowed power, then as the trigger 270 remains activated it uses a power level that is 1-2 db greater than the previous read. As is known by the practitioner in the art, the amount of power increase depends on the power level step provided by the module design. When the trigger 270 is released, the reading of an RFID tag stops. If the maximum power level is reached before the trigger is released then the reading of an RFID tag stops automatically.

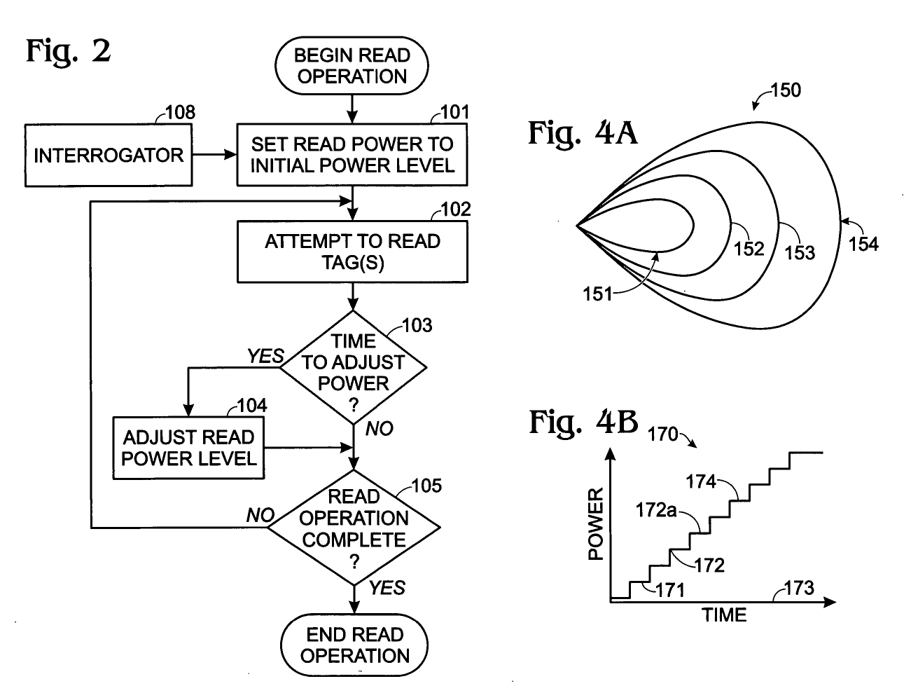

When the trigger 270 engerzies the RFID reader, the singulation scheme 100 (FIG. 2) would give a high probability of initially reading only those tags that are in close proximity to the antenna 44, that is, directly ahead of the antenna. As RF transmitting power increases, the read volume grows steadily up to the maximum that a particular RFID reader permits. The singulation scheme 100 provides better restriction of the read zone than does, for example, a tight (narrow) antenna beam. In addition, the singulation scheme 100 does not require a change from a typical trigger 270 mechanism or a switchable antenna. Alternately, it might be desirable to have a software switch, that is, a dialog box or the like. The singulation scheme 100 is selectable by using a long trigger pull, a double-click on a trigger, a quick release of a trigger, software menu selection, another trigger or automatic selection. The automatic selection of the singulation scheme 100 could occur by prefacing the read sequence with a single low-power read just sufficient to read a tag touching the antenna.

Referring to FIG. 2, singulation scheme 100 illustrates a preferred embodiment using a power ramping software algorithm, which allows a trigger pull to activate and operate the process. The process begins at step 101, where the initial power level to read RFID tags is established and configured at the interrogator 108. The process continues to step 102, wherein the interrogator 108 is instructed to attempt to read an RFID tag at the current power level. At step 103, the rate of power ramping is used to determine if the power used to read tags should be adjusted. For example, the criteria used to make this decision could be based on the amount of time a read attempt was made at step 102. Alternately, antenna sensitivity or a combination of antenna sensitivity and time spent reading a tag could be used. Once it is determined that the power level should be adjusted, step 104 reconfigures the new power setting at the interrogator 108. Step 105 determines if the read operation should stop, which is based on whether or not a tag has been read. If not, then the process repeats beginning at step 102. Otherwise, the read operation ends which involves reporting the tag(s) read, and/or powering down the interrogator 108.

The singulation scheme 100 reads one specific RFID tag in the presence of other tags. The preferred embodiment to accomplish singulation is obtained by increasing the transmitting power. This increased power expands the sensing read volume 150 (FIG. 4A), that is, the region of space around the antenna in which the RFID tag will respond. The sensing read volume 150 increases in direct proportion to the transmitter power 170 (FIG. 4B) and maintains exactly the same shape as it expands. A read volume expands, for example, like a balloon when air is added to it. Depending on the transmitter power 170, the sensing read volume 150 will increase to volumes 151, 152, 153 and 154, covering a greater region in which there are RFID tags to read.

In a preferred configuration, RFID readers have some kind of software-driven transmitter-power control 170. The power steps are commonly on the order of about 1 db or less starting, for example, at less than about 0.1 W. (The maximum power allowed by the FCC for RFID is 1 W). When a singulation scheme is entered into with a RFID reader, the transmitter power is started at a first low value 171 and the reader attempts to read a tag at a first sensing read volume 151, which is the maximum volume that could be read at the first low value 171. The singulation scheme would then pause for a short period, but long enough for a user to respond, then repeat with the power increasing by a given small increment. For example, the transmitter power could be increased to a second value 172 and attempt to read tags at a second sensing volume 152, which is the maximum volume that could be read at the second value 172. The singulation scheme would be repeated until either maximum power is reached or the user terminates it. For example, early termination might occur because the desired tag has been read. The sense read volume 150 would initially encompass only RFID tags rather close to the RFID reader and generally immediately in front of it. As shown by arrow 173 in FIG. 4B, as RF transmitting power increases the sense read volume expands in all directions as show in FIG. 4A providing sensing read volumes 151, 152, 153 and 154. As the read volume grows, the number of tags within the volume would increase.

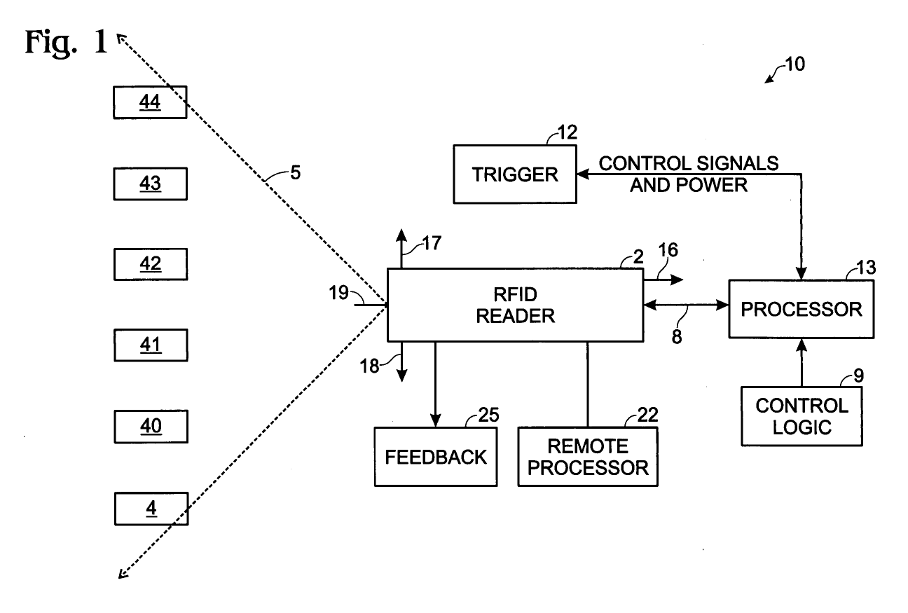

Now referring to FIG. 1, RFID apparatus 10 illustrates a block diagram of a preferred embodiment. The apparatus 10 uses a RFID reader 2 to scan for a particular RFID tag(s) in a plurality of RFID tags, including but not limited to, 4, 40, 41, 42, 43 and 44. The RFID apparatus 10 is preferably a handheld RFID reader 2, wherein the RFID reader 2 passes over the RFID tags 4, 40, 41, 42, 43 and 44. Alternately, the RFID reader 2 is substitutable for a fixed reader, wherein RFID tags 4, 40, 41, 42, 43 and 44 are passed in front of the reader. The RFID reader 2 may be connected via a USB link 8 or other interfaces to processor 13. The interface link can be hardwired to an infrared modem connection, an RF modem connection, a combination of connections or any other suitable connections. RFID reader 2 may also include a self-contained micro-processor and be capable of storing data, and may or may not interface with a remote processor 22. Processor 13 receives control input from logic control 9 for communication with RFID reader 2. Logic control 9 may be programmable and part of processor 13 or may be separate. An activation switch, such as trigger 12, provides control signals and power to processor 13. Consequently, the switch may implement a singulation scheme 100 to locate a particular RFID tag, for example, tag 41 from amongst RFID tags 4, 40, 41, 42, 43 and 44. In addition, a bar code scanner may use the principles of the preferred embodiment as described in this disclosure. Such bar code scanner that provides bar code image signals by a digitizer circuit is described in U.S. Pat. No. 5,864,129, issued to Boyd, entitled “Bar Code Digitizer Including Voltage Comparator,” the entire contents of said patent are incorporated herein by reference and made part of this disclosure.

The power-density-time (PDT) control that provides a ramped power control is accomplished by use of a singulation trigger (device) 12. The singulation scheme 100 would begin when the trigger 12 is pulled and held. The read would continue for as long as the trigger 12 is held, up to the point of maximum power. Depending on what RFID tag is to be identified from the tags 4, 40, 41, 42, 43 and 44, the trigger 12 would be pulled to generate a transmitter power 170. The transmitting power 170 would provide the desired sensing volume 150, wherein a particular tag is identified from among the tags, 4, 40, 41, 42, 43 and 44. In addition to trigger 12, the system 10 may optionally include a feedback mechanism 25. One such mechanism may comprise a progress bar on a LCD increasing as the transmitting power 170 increases. This feedback allows the user to judge whether or not the read effort is successful because a singulation read may take longer than a normal read. Alternately, the feedback mechanism 25 may comprise an auditory feedback that generates an audible signal when a RFID tag is read or when maximum power is achieved. This auditory feedback may include, but is not limited to, increasing a pitch sequence of tone-beeps working with the transmitter power.

In referring to FIG. 1, the singulation scheme 100, as shown in FIG. 2 is a method of RFID power ramping for tag singulation that includes activating the singulation trigger 12 control of an RFID reader 2. The trigger (device) activations engages the RF transmitting power 170 to read RFID tags in the direction the RFID reader 2 is pointing such as RFID tags 4, 40, 41, 42, 43 and 44. As is known by the practitioner in the art, there could be an unlimited number of tags to be read or the tags could also be grouped into specific sets of tags, wherein each group of tags contain specific information. The user commences reading tags by pulling on the trigger 12, transmitting power 170 from the reader at a low first power level 171 obtaining a first reading of RFID tags encompassing a first sensing read volume 151. The trigger activation includes, but is not limited to, increasing or decreasing a certain amount of pressure on the trigger for a period of time by pulling back on the trigger or intermitantly pulling back (rapid increase and decrease of pressure) on the trigger. If a tag is not singulated, that is detected, the user may increase the transmitting power 170 by continued pulling on trigger 12 to a second power level 172 encompassing a second sensing read volume 152 for obtaining a second reading of the RFID tags. If an RFID tag is still not singulated, that is detected, the user may then increase the transmitting power 170 from the RFID reader 2 to a third higher power level 172a obtaining a third reading of RFID tags encompassing a third sensing read volume 153. At the next step, if a tag has not been singulated, the user once again increases the transmitting power 170 from the RFID reader 2 to a fourth higher power level 174 obtaining a fourth reading of RFID tags encompassing a fourth sensing reading volume 154. If a tag is not singulated, the continuation of the RFID power ramping is repeated until an operator identifies a final read volume where the desired RFID tag is detected and read. The final step includes deactivating the trigger 12 control of the RFID reader 2 after reading the detected RFID tag. Finally, the method may only require one reading or several readings, and depends upon where and in what read volume the user is able to singulate the desired tag. Likewise, these steps and principles of the preferred embodiment are usable in U.S. Pat. 5,864,129, issued to Boyd, entitled “Bar Code Digitizer Including Voltage Comparator,∞ the entire contents of said patent are incorporated herein by reference and made part of this disclosure.

In FIG. 3, the singulation scheme 100, as shown in FIG. 2, is a method of RFID power ramping for tag singulation that includes activating the singulation trigger (device) control 270 of an RFID reader 228b for engaging power to read RFID tags. Before taking a reading, the user may manually increase power by pulling back on the trigger 270 transmitting power 170 from the reader establishing a low first power level 171 and obtaining a first reading of RFID tags in a first sensing read volume 151. Alternately, the user may take the first reading without first increasing the transmitting power. If a tag is not singulated, that is detected, the user may again pull the trigger 270 increasing the transmitting power 170 from the RFID reader 228b to a second higher power level 172, obtaining a second reading of RFID tags in a second read volume 152. If a tag is not yet singulated, the next step includes taking a third reading at a third higher power level 172a, encompassing a larger volume around the RFID reader 228b providing a third sensing read volume 153. If a tag is not singulated by the third reading, the user may again pull back on trigger 270 increasing the transmitting power 170 from the RFID reader 228b to at least a fourth higher power 174 level obtaining at least a fourth reading of RFID tags in a fourth sensing volume 154. If a tag is not yet detected, the continuation of the RFID power ramping is repeated until an operator identifies a final read volume where the desired RFID tag is detected and read. The final step includes deactivating the trigger 270 control of the RFID reader 228b after reading the desired RFID tag which is manual or automatic at the desired power level. Finally, the method may only require one reading or several readings and depends upon where and in what read volume the user is able to singulate the desired tag.

In another embodiment (inventory mode), the singulation scheme 100 as illustrated in FIG. 2, starts out with transmitting low power 171, queries any RFID tag within the first sensing volume 151 and then turns the detected RFID tags off. In the next increment of the sensing volume 150, the tags in the first sensing volume 151 do not respond, so only tags in the newly expanded region of the second sensing volume 152 respond with increased transmitting power 172. The RFID tags in the newly expanded region of the second sensing volume 152 are also turned off and the transmitting power 170 in increased. The process is repeated until maximum power or some other criteria are reached. The result is that each successive read queries a relatively thin region of space and possible collisions in the RF signal responses of the tags are reduced. Consequently, tags are easier to locate since the region in space generating possible responses is smaller.

Referring to FIG. 1, there are several methods to switch between inventory and singulation modes of operation for RFID reader 10. The ways to select between inventory or singulation modes and operate in the singulation mode include a double-click on the trigger 12, a long or short trigger 12 pull, a rocker trigger 12 or a force or rate sensitive trigger 12. Alternately, there may be separate triggers 12, one for the inventory mode and the other for the singulation mode. Once the user is in the singulation mode, the preferred embodiment is to use the ramping power technique for increasing RF transmitting power and increasing the sensing read volume. The techniques include, but are not limited to linear stepping (FIG. 4B), linear, gradual, continuous or logarithmic power increase to singulate a tag in response to the trigger 12 being held down (pulled). There are many techniques to ramp (increase) power using electronic circuits.

Using RFID apparatus 10 from FIG. 1, singulation may also be accomplished by a method that first directs the antenna 19, which can be moved in the direction of the arrows 17 and 18 into close proximity of a tag 42. Next, a user of apparatus 10 activates the trigger 12 of the RFID reader 2 so that it issues a read attempt at low RF transmitting power. If the RF power is sufficient for a tag 42 to respond, the tag 42 responded because the volume was large enough to enclose the target tag. For example, for only tag 42 to respond, the RF power must be at a level so that volume 151 (FIG. 4A) is a size that may include tags 4, 40, 41, 43 and 44, but must include tag 42. If tag 42 is detected, the RFID reader 2 will issue no more reads until the trigger 12 of the RFID reader 2 is operated by the user. The tag information is then presented to the user or to the processor 13. Likewise, the principles of the preferred embodiment may be used in U.S. Pat. No. 6,024,284, issued to Schmid et al., entitled “Wireless Bar Code Scanning System,” the entire contents of said patent are incorporated herein by reference and made part of this disclosure.

If the RF power is not sufficient for a tag 42 to respond or the volume is not large enough that it encloses tag 42, then the RFID reader 2 issues read attempts increasing RF power, that is increasing read volume, until tag 42 is read. When tag 42 is detected, the RFID reader 2 will automatically issue no more reads, saving power, and then the reader will present the tag 42 information to the user or the processor 13. The RFID reader will power down after the desired tag is detected and the information is presented to the user or the processor 13.

The trigger 270 (FIG. 3) may be used to adjust the RF power transmitted by the RFID reader 240 when the position of the antenna 44 is directed relative to a single RFID tag of interest. That tag can be singulated with its individual identity read, even though more tags may be present within the normal read volume of the RFID reader 240 and its antenna 44. In other words, other nearby tags are excluded through singulation. For example, a user of apparatus 200 directs the antenna 44 at a desired tag and then activates the trigger 270 of the RFID reader 240 so that it issues a read attempt at low RF power. If the RF power is sufficient for a tag to respond, the tag responds because the volume is large enough so that it encloses the target tag. The RFID reader 240 then shuts off and issues no more reads until the trigger 270 of the RFID reader 240 is operated by the user. The tag information is then presented to the user or to the processor 260.

If the RF power is not sufficient for a tag to respond or the volume is not large enough that it encloses the tag, the RFID reader 240 will then issue read attempts increasing the RF power. That is increasing the read volume until a particular tag is read. The tag which is detected or singulated may be the closest tag from the antenna or it may be the farthest. In any case, the detected tag will be in a particular read volume where the size of the read volume is proportional to the amount of RF power transmitted. The RFID reader 240 will then automatically shut down, saving power, and will present the tag information to the user or the processor 260. When more than one tag is to be read, the RFID reader 240 will issue read attempts at decreasing power (decreasing read volume) until the tags are read. This may be done manually or automatically through the use of a preprogrammed microprocessor. The RFID reader 240 will shut down and the tag information of the selected tags will be presented to the user or the processor 260.

While there has been illustrated and described with reference to certain embodiments, it will be appreciated that numerous changes and modifications are likely to occur to those skilled in the art. It is intended in the appended claims to cover all those changes and modifications that fall within the spirit and scope of this disclosure and should, therefore, be determined only by the following claims and their equivalents.

What is claimed is:

1. A method of power ramping in an RFID reader for tag singulation comprising the steps of:
activating the trigger control of said RFID reader for engaging power to begin reading RFID tags;
transmitting power from said RFID reader at a first power level and obtaining a first read volume and first reading of said RFID tags;
increasing said transmitting power from said RFID reader to a higher power level for obtaining a larger read volume and reading additional RFID tags within said larger read volume;
repeating the step of increasing said transmitting power from said RFID reader to a higher power level until detecting a desired RFID tag in a final read volume; and
deactivating the trigger control of said RFID reader after reading said desired RFID tag.

2. The method as claimed in claim 1, wherein said trigger control uses a plurality of power ramping techniques.

3. The method as claimed in claim 1, wherein said activating of the trigger uses a plurality of methods to switch from inventory to singulation mode.

4. The method as claimed in claim 1, wherein said deactivating of the trigger is automatic at a desired power level.

5. The method as claimed in claim 1, wherein said deactivating of the trigger is manual at a desired power level.

6. The method as claimed in claim 1, wherein said sensing volume increases in direct proportion to said transmitting power; said sensing read volume maintaining a balloon shape when said read volume expands.

7. A method of power ramping in an RFID reader for tag singulation comprising the steps of:
directing an antenna of said RFID reader to read an RFID tag;
activating a trigger on said RFID reader at a first RF transmitting power to read said tag;
wherein when said RF transmitting power is sufficient for said tag to respond, said tag will respond because a read volume is large enough that it encompasses said tag, said RFID reader ceases transmitting and receiving;
wherein when said RF transmitting power is not sufficient for said tag to respond, said tag does not respond because said read volume is not large enough to encompass said tag, then said RFID reader attempts reading at increasing RF transmitting power until said tag is read in a final read volume and said RFID reader ceases transmitting and receiving; and
presenting said tag information.

8. The method as claimed in claim 7, wherein said tag information is presented to a user.

9. The method as claimed in claim 7, wherein said tag information is presented to a processor.

10. A data reader comprising:
a) a radio frequency identification (RFID) interrogator within said data reader for detecting data;
b) a processor connected to an output of said RFID interrogator;
c) a feedback unit connected to said output; and
d) a singulation trigger for ramping power transmitted from said RFID interrogator for detecting an RFID tag from a plurality of read volumes.

11. The claim as claimed in claim 10, wherein said ramping power transmitted from said RFID interrogator uses a plurality of techniques having electronic circuits.

12. The claim as claimed in claim 10, wherein said singulation trigger is a plurality of activation devices.

13. A multiple technology data reader comprising:
a) a housing;
b) an optical data reader;
c) a radio frequency identification (RFID) interrogator for detecting data;
d) a communications unit connected to said optical data reader and said RFID interrogator; and
e) a singulation trigger for ramping power transmitted from said RFID interrogator for detecting an RFID tag from a plurality of read volumes.

14. The claim as claimed in claim 13, wherein said ramping power transmitted from said RFID interrogator uses a plurality of techniques having electronic circuits.

15. The claim as claimed in claim 13, wherein said singulation trigger is a plurality of activation devices.
